(19) United States
(12) Patent Application Publication
(10) Pub. No.: US 2024/0038984 A1
(43) Pub. Date: Feb. 1, 2024

(54) MODIFIED CATHODE FOR HIGH-VOLTAGE LITHIUM-ION BATTERY AND METHODS OF MANUFACTURING THEREOF

(71) Applicants: CORNING INCORPORATED, Corning, NY (US); SHANGHAI INSTITUTE OF CERAMICS, CHINESE ACADEMY OF SCIENCES, Shanghai (CN)

(72) Inventors: Michael Edward Badding, Campbell, NY (US); Jun Jin, Shanghai (CN); Zhen Song, Painted Post, NY (US); Zhaoyin Wen, Shanghai (CN); Tongping Xiu, Shanghai (CN); Liu Yao, Shanghai (CN)

(21) Appl. No.: 18/330,767

(22) Filed: Jun. 7, 2023

Related U.S. Application Data
(60) Provisional application No. 63/369,530, filed on Jul. 27, 2022.

(51) Int. Cl. H01M 4/525; H01M 10/0525; H01M 10/0562; H01M 10/0568; H01M 4/505; H01M 4/58; H01M 4/36

(52) U.S. Cl. CPC H01M 4/525; H01M 10/0525; H01M 10/0562; H01M 10/0568; H01M 4/505; H01M 4/58; H01M 4/366

(57) ABSTRACT

A composition includes a first portion including Ni-rich LiNiₓCo_{y}Mn_{z}O₂, where 0.5<x<1, 0<y<1, 0<z<1; a second portion including Li₃PO₄ such that the second portion is coated on the first portion, and the first portion is doped with an elemental metal selected from at least one of Zr, Sn, Nb, Ta, Al, and Fe. The molar ratio between Li₃PO₄ and Ni-rich LiNixCoyMnzO2 ranges from 0.76:100 to 3.8:100. A method of forming a composition includes mixing a metal precursor with nickel-cobalt-manganese (NCM) precursor to form a first mixture; adding a lithium-based compound to the first mixture to form a second mixture; and calcining the second mixture at a predetermined temperature for a predetermined time to form the composition.

### CROSS REFERENCE TO RELATED APPLICATION

This Application claims the benefit of priority under 35 U.S. § 119 of U.S. Provisional Application Ser. No.: 63/369,530 filed on Jul. 27, 2022, the content of which is relied upon and incorporated herein by reference in its entirety.

### BACKGROUND

### Field

This disclosure relates to modified cathodes for high-voltage lithium-ion batteries (LIBs) and methods of manufacturing thereof.

### TECHNICAL BACKGROUND

Rechargeable lithium-ion batteries (LIBs) have been widely commercialized in portable electronics and electric vehicle applications. Cathode materials play an important role in electrochemical performance and safety of the LIBs.

The present application discloses improved cathodes with high capacity and stability and low cost (and methods of formation thereof) for lithium-ion battery (LIB) applications.

### SUMMARY

In some embodiments, a composition, comprises: a first portion including Ni-rich LiNiₓCo_{y}Mn_{z}O₂, where 0.5<x<1, 0<y<1, 0<z<1; a second portion including Li₃PO₄, wherein: the second portion is coated on the first portion, and the first portion is doped with an elemental metal selected from at least one of Zr, Sn, Nb, Ta, Al, and Fe. The molar ratio between Li₃PO₄ and Ni-rich LiNixCoyMnzO2 ranges from 0.76:100 to 3.8:100.

In one aspect, which is combinable with any of the other aspects or embodiments, the elemental metal is Al.

In some embodiments, a lithium-ion battery, comprises: a cathode; an electrolyte; and a lithium anode, wherein the cathode comprises: a first portion including Ni-rich LiNiₓCo_{y}Mn_{z}O₂, where 0.5<x<1, 0<y<1, 0<z<1; a second portion including Li₃PO₄, wherein: the second portion is coated on the first portion, and the first portion is doped with an elemental metal selected from at least one of Zr, Sn, Nb, Ta, Al, and Fe.

In one aspect, which is combinable with any of the other aspects or embodiments, the electrolyte is a solid-state electrolyte.

In one aspect, which is combinable with any of the other aspects or embodiments, the solid-state electrolyte comprises: (i) Li₇₋₃ₐLa₃Zr₂LₐO₁₂, with L=Al, Ga or Fe and 0<a<0.33; (ii) Li₇La_{3-b}Zr₂M_{b}O₁₂, with M=Bi or Y and 0<b<1; and (iii) Li_{7-c}La₃(Zr_{2-c},N_{c})O₁₂, with N=In, Si, Ge, Sn, V, W, Te, Nb, or Ta and 0<c<1.

In one aspect, which is combinable with any of the other aspects or embodiments, the solid-state electrolyte comprises: Li_{6.4}La₃Zr_{1.4}Ta_{0.6}O₁₂, Li_{6.5}La₃Zr_{1.5}Ta_{0.5}O₁₂, or combinations thereof.

In one aspect, which is combinable with any of the other aspects or embodiments, the solid-state electrolyte comprises: Li₁₀GeP₂S₁₂, Li_{1.5}Al_{0.5}Ge_{1.5}(PO₄)₃, Li_{1.4}Al_{0.4}Ti_{1.6}(PO₄)₃, Li_{0.55}La_{0.35}TiO₃, interpenetrating polymer networks of poly(ethyl acrylate) (ipn-PEA) electrolyte, three-dimensional ceramic/polymer networks, in-situ plasticized polymers, composite polymers with well-aligned ceramic nanowires, PEO-based solid-state polymers, flexible polymers, polymeric ionic liquids, in-situ formed Li₃PS₄, Li₆PS₅Cl, or combinations thereof.

In one aspect, which is combinable with any of the other aspects or embodiments, the electrolyte is a liquid electrolyte.

In one aspect, which is combinable with any of the other aspects or embodiments, the liquid electrolyte comprises: LiPF₆, LiBF₄, LiClO₄, lithium chelatoborates (e.g., lithium bis(oxalato)borate), electrolyte additive agents, fluoroethylene carbonate (FEC), tris(trimethylsilyl)phosphate (TMSP), vinylene carbonate (VC), or combinations thereof, in an organic solvent.

In one aspect, which is combinable with any of the other aspects or embodiments, the elemental metal is Al.

In some embodiments, a method of forming a composition, comprises: mixing a metal precursor with nickel-cobalt-manganese (NCM) precursor to form a first mixture; adding a lithium-based compound to the first mixture to form a second mixture; and calcining the second mixture at a predetermined temperature for a predetermined time to form the composition.

In one aspect, which is combinable with any of the other aspects or embodiments, the composition comprises: a first portion including Ni-rich LiNiₓCo_{y}Mn_{z}O₂, where 0.5<x<1, 0<y<1, 0<z<1; a second portion including Li₃PO₄, wherein: the second portion is coated on the first portion, and the first portion is doped with an elemental metal selected from at least one of Zr, Sn, Nb, Ta, Al, and Fe.

In one aspect, which is combinable with any of the other aspects or embodiments, the metal precursor is selected from at least one of a Zr-, Sn-, Nb-, Ta-, Al-, and Fe-precursor.

In one aspect, which is combinable with any of the other aspects or embodiments, the metal precursor is a Al-precursor.

In one aspect, which is combinable with any of the other aspects or embodiments, the lithium-based compound is selected from at least one of Li₂CO₃, LiOH, LiNO₃, and CH₃COOLi.

In one aspect, which is combinable with any of the other aspects or embodiments, the predetermined temperature is in a range of 700° C. to 1200° C. and the predetermined time is in a range of 8 hrs to 15 hrs.

### BRIEF DESCRIPTION OF THE DRAWINGS

The disclosure will become more fully understood from the following detailed description, taken in conjunction with the accompanying figures, in which:

FIG. 1 illustrates a general structure of a high-voltage lithium-ion battery (LIB), according to some embodiments.

FIG. 2 illustrates a schematic diagram of a synthetic process for forming modified NCM622 particles, according to some embodiments.

FIG. 3 illustrates full region (FIG. 3a) and enlarged region (FIG. 3b and FIG. 3c) of X-ray diffraction (XRD) patterns of cathodes comprising modified NCM622 material with varying contents of AlPO₄, according to some embodiments.

FIG. 4 illustrates a transmission electron microscopy (TEM) image (FIG. 4a) and selected area electron diffraction (SAED) pattern image (FIG. 4b) of a cathode comprising modified NCM622 material, according to some embodiments.

FIG. 5 illustrates P 2p (FIG. 5a) and Al 2p (FIG. 5b) of X-ray photoelectron spectroscopy (XPS). FIG. 5c illustrates inductive coupled plasma mass spectrometry (ICP-MS) results and XPS results of element ratios, according to some embodiments.

FIG. 6 illustrates charge-discharge curves (FIG. 6a) and cycling performances (FIG. 6b) of liquid electrolyte battery, according to some embodiments.

FIG. 7 illustrates charge-discharge curves (FIG. 7a) and cycling performances (FIG. 7b) of quasi-solid-state electrolyte battery.

### DETAILED DESCRIPTION

Reference will now be made in detail to exemplary embodiments which are illustrated in the accompanying drawings. Whenever possible, the same reference numerals will be used throughout the drawings to refer to the same or like parts. The components in the drawings are not necessarily to scale, emphasis instead being placed upon illustrating the principles of the exemplary embodiments. It should be understood that the present application is not limited to the details or methodology set forth in the description or illustrated in the figures. It should also be understood that the terminology is for the purpose of description only and should not be regarded as limiting.

Additionally, any examples set forth in this specification are illustrative, but not limiting, and merely set forth some of the many possible embodiments of the claimed invention. Other suitable modifications and adaptations of the variety of conditions and parameters normally encountered in the field, and which would be apparent to those skilled in the art, are within the spirit and scope of the disclosure.

The present disclosure relates to high-voltage LIBs, and more particularly to modified, Ni-rich LiNiₓCo_{y}Mn_{z}O₂ (NCM, 0.5<x<1, 0<y<1, 0<z<1) cathode-based high voltage batteries. In some embodiments, the high-voltage LIB may comprise modified NCM (e.g., LiNi_{0.6}Co_{0.2}Mn_{0.2}O₂) coated with Li₃PO₄ and elementally doped with a metal (e.g., Zr, Sn, Nb, Ta, Al, Fe, etc.) to enhance cycling stability and rate capacity of the battery.

It is contemplated that NCM may be used as a promising cathode material due to its high energy density, low cost, and increased specific capacity. However, surface structural degradation of NCM accelerates at elevated voltages, causing LIB capacity fading and safety issues. Aiming at solving these problems, the present specification discloses a surface coating to effectively inhibit unwanted side reactions within the LIB and a doping scheme to enhance the structural stability.

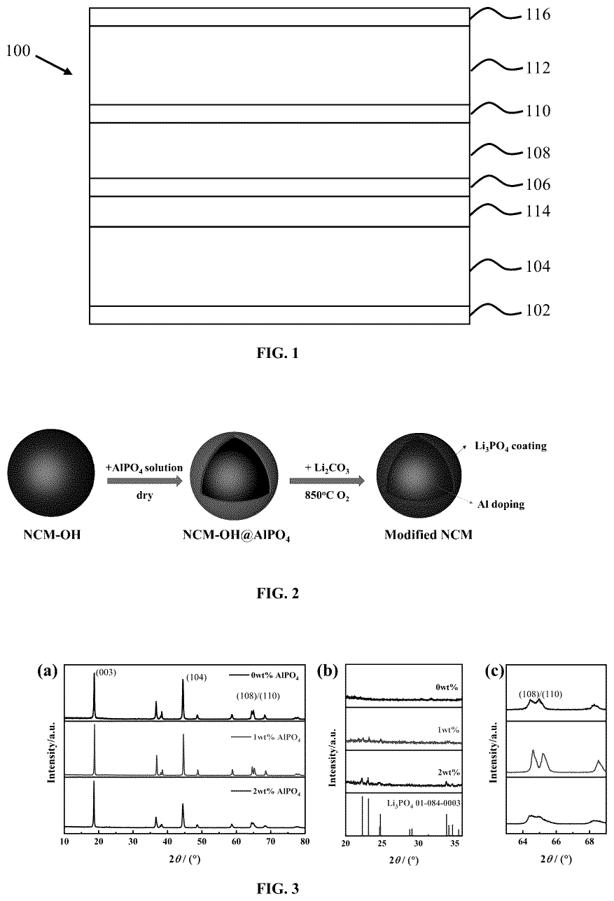

FIG. 1 illustrates a general structure of a high-voltage lithium-ion battery (LIB), according to some embodiments. It will be understood by those of skill in the art that the processes described herein can be applied to other configurations of LIB structures.

In some embodiments, battery 100 may include a substrate 102 (e.g., a current collector), a cathode 104 disposed on the substrate, an optional coating layer 114 disposed on the cathode, an optional first interlayer 106 disposed on the coating layer, a electrolyte 108 (e.g., solid-state and/or liquid electrolytes) disposed on the first interlayer, an optional second interlayer 110 disposed on the electrolyte, a lithium electrode (e.g., anode) 112 disposed on the second interlayer, and a second current collector 116 disposed on the anode. These can be disposed horizontally in relation to each other or vertically.

In some examples, the substrate 102 may a current collector including at least one of three-dimensional nickel (Ni) foam, carbon fiber, foils (e.g., aluminum, stainless steel, copper, platinum, nickel, etc.), or a combination thereof.

In some examples, the interlayer 106 and 110 may be independently chosen from at least one of carbon-based interlayers (e.g., interlinked freestanding, micro/mesopore containing, functionalized, biomass derived), polymer-based interlayers (e.g., PEO, polypyrrole (PPY), polyvinylidene fluoride, etc.), metal-based (e.g., Ni foam, etc.), or a combination thereof. In some examples, at least one of interlayers 106 or 110 may be PEO₁₈LiTFSI-10% SiO₂-10% IL (combination of polyethylene oxide (PEO), bis(trifluoromethane) sulfonimide lithium salt (LiN(CF₃SO₂)₂, or LiTFSI), SiO₂ nanoparticles and ionic liquid (IL)).

In some examples, electrolyte 108 may be solid-state electrolytes, which have attracted ever-increasing attention because they are able to address common safety concerns such as leakage, poor chemical stability, and flammability often seen in LIBs employing liquid electrolytes, especially under exertive conditions like extended operational time frames and elevated cycling temperatures. For example, LLZO-based electrolytes have high ionic conductivity and wide electrochemical windows, which are desirable for solid-state high-voltage LIBs.

In some examples, the solid-state electrolyte may include at least one of LLZO-based (i.e., compounds comprising lithium, lanthanum, zirconium, and oxygen elements such as at least one of (i) Li₇₋₃ₐLa₃Zr₂LₐO₁₂, with L=Al, Ga or Fe and 0<a<0.33; (ii) Li₇La_{3-b}Zr₂M_{b}O₁₂, with M=Bi or Y and 0<b<1; (iii) Li_{7-c}La₃(Zr_{2-c},N_{c})O₁₂, with N=In, Si, Ge, Sn, V, W, Te, Nb, or Ta and 0<c<1 (e.g., Li_{6.4}La₃Zr_{1.4}Ta_{0.6}O₁₂, Li_{6.5}La₃Zr_{1.5}Ta_{0.5}O₁₂, etc.); or combinations thereof), Li₁₀GeP₂S₁₂, Li_{1.5}Al_{0.5}Ge_{1.5}(PO₄)₃, Li_{1.4}Al_{0.4}Ti_{1.6}(PO₄)₃, Li_{0.55}La_{0.35}TiO₃, interpenetrating polymer networks of poly(ethyl acrylate) (ipn-PEA) electrolyte, three-dimensional ceramic/polymer networks, in-situ plasticized polymers, composite polymers with well-aligned ceramic nanowires, PEO-based solid-state polymers, flexible polymers, polymeric ionic liquids, in-situ formed Li₃PS₄, Li₆PS₅Cl, or combinations thereof. Methods of formation of the electrolyte 108 are described in the Examples below.

In some examples, the anode 112 may comprise lithium (Li) metal. In some examples, the battery may include at least one anode protector such as electrolyte additives (e.g., LiNO₃, lanthanum nitrate, copper acetate, P₂S₅, etc.), artificial interfacial layers (e.g., Li₃N, (CH₃)₃SiCl, Al₂O₃, LiAl, etc.), composite metallics (e.g., Li₇B₆, Li-rGO (reduced graphene oxide), layered Li-rGO, etc.), or combinations thereof. In some examples, a thin layer of metal (e.g., Au) may be ion-sputter coated to form a contact interface between the anode 112 and first interlayer 106 or between the anode and electrolyte 108. In some examples, a thin layer of silver (Ag) paste may be brushed to a surface of the electrolyte 108 to form a close contact between the anode 112 and electrolyte 108.

In some examples, the coating layer 114 may comprise at least one of carbon polysulfides (CS), polyethylene oxides (PEO), polyaniline (PANI), polypyrrole (PPY), poly(3,4-ethylenedioxythiophene) (PEDOT), polystyrenesulfonic acid (PSS), polyacrylonitrile (PAN), polyacrylic acid (PAA), polyallylannine hydrochloride (PAH), poly(vinylidene fluoride-co-hexafluoropropylene) (P(VdF-co-HFP)), poly(methylmethacrylate) (PMMA), polyvinylidene fluoride (PVDF), poly(diallyldinnethyl ammonium) bis(trifluoronnethanesulfonyl)innide (TFSI) (PDDATFSI), lithium salts (e.g., bis(trifluoronnethane) sulfoninnide lithium salt (LiN(CF₃SO₂)₂)(LiTFSI), lithium perchlorate, lithium bis(oxalato) borate (LiBOB), lithium bis(fluorosulfonyl)innide (LiFSI), lithium trifluoronnethanesulfonate (LiCF₃SO₃) (LiTf), lithium bis(trifluoronnethanesulfoninnide) (Li(C₂F₅SO₂)₂N) (LiBETI), etc.), or combinations thereof.

In some examples, the coating layer 114 may comprise a lithium-rich additive (e.g., Li₃PO₄). In some examples, where the lithium-rich additive coating layer directly contacts a solid-state LLZO-based electrolyte, the lithium-rich additive coating layer may help to reduce the sintering temperature of the LLZO-based electrolyte and create a lithium atmosphere during electrolyte sintering, which simplifies the sintering process and reduces its cost.

Description of the cathode 104 and methods of formation are described in the Examples below.

### EXAMPLES

As explained in the examples below, a kind of co-modified NCM cathode with a Li₃PO₄ coating and elemental Al doping is disclosed for high-voltage lithium-ion batteries. This cathode was prepared by a facile one-step method using a AlPO₄ solution and nickel-cobalt-manganese (NCM) precursor (NCM-OH; where Ni_{d}CoₑMn_{f}(OH)₂, 0.5<d<1, 0<e<1, 0<f<1). The modified NCM cathode exhibits a greatly enhanced cycling stability (capacity retention of 84.4% after 300 cycles at 0.2 C) over 2.8-4.5 V in liquid electrolyte battery due to the Li₃PO₄ coating and Al doping. Quasi-solid-state batteries based on this type of cathode delivered discharge capacity of 148.8 mAhg-1 with high-capacity retention of 88.3% after 100 cycles at 0.2 C over 2.8-4.5 V.

### Example 1—Preparation of AlPO₄ Solution

The AlPO₄-based non-aqueous solution was synthesized by the reaction of phosphate ester and Al(NO₃)₃·9H₂O in ethanol solution. Typically, 7.1 g P₂O₅ was dissolved in 80 g ethanol first to form solution A, and also 37.5 g Al(NO₃)₃·9H₂O was dissolved in 80.0 g of ethanol to form solution B. Then, solution A and solution B were mixed and stirred at 50° C. for 3 hours. After the reaction, 22.08 g (NH₄)₂CO₃ was added slowly into the solution until the pH value was adjusted to ˜7.0. Note that there is no any precipitation (e.g., AlPO₄) in this step. Finally, the NH₄NO₃ can be salted out from the solution after cooling the solution to −10° C. and then give rise to a clear AlPO₄-based solution by the filtration of NH₄NO₃. The result AlPO₄ solution was then diluted to 1.0 wt % in ethanol.

### Example 2—Preparation of Modified NCM622 (M-NCM622) Powders

The precursor powders commercial NCM622-OH (e.g., Ni_{0.6}Co_{0.2}Mn_{0.2}(OH)₂) (diameter, Φ=3-20 μm) were firstly mixed with varying amounts of AlPO₄ materials: 0 wt. %, 1 wt. % to 2 wt. % (e.g., 2 wt. %) and 2 wt. % to 5 wt. % (e.g., 5 wt. %) by stirring to dry at 60° C. Converted to molar ratio, the molar ratio between Li₃PO₄ and Ni-rich LiNixCoyMnzO2 ranges from 0.76:100 to 3.8:100.

Then, lithium carbonate (Li₂CO₃) (>98%, 5% excess) was added by hand grinding in the agate mortar for 15 min. Lithium-based compounds are used as a lithium source to react with both NCM622-OH and AlPO₄ to obtain NCM particles comprising a Li₃PO₄ coating layer. Other lithium compounds that can also be used are LiOH, LiNO₃, and CH₃COOLi.

Thereafter, the mixture (NCM622-OH, AlPO₄, and Li₂CO₃) was calcinated at 850° C. for 12 hrs in oxygen to obtain modified NCM622 powders. Aluminum substitutes in for transition metal sites during the high temperature sintering process (“Al-doped”).

In some examples, the calcining temperature is in a range of 700° C. to 1200° C. (e.g., 850° C.), or 700° C. to 1000° C., or 700° C. to 900° C., or any value or range disposed therein. In some examples, the calcining time is in a range of 8 hrs to 15 hrs (e.g., 12 hrs), or 10 hrs to 15 hrs, 10 hrs to 13 hrs, or any value or range disposed therein.

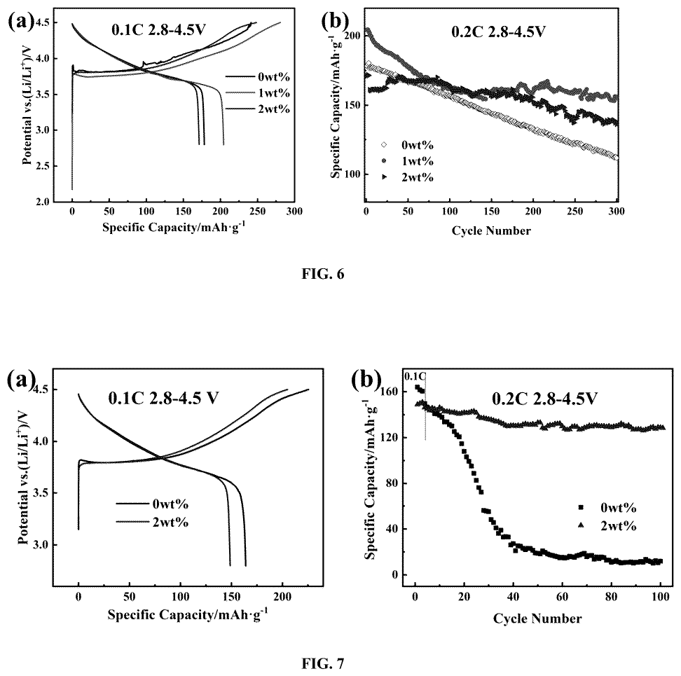

FIG. 2 illustrates a schematic diagram of a synthetic process for forming modified NCM622 particles, according to some embodiments. The AlPO₄ modification shows tendency to form dual modification of Li₃PO₄ coating and Al doping concurrently. The Li₃PO₄ coating improves the interface stability and cycling performance according to FIG. 6b and FIG. 7b. The Al doping can enhance the cathode structure stability and deliver more discharge capacity with proper ratio (e.g. 1 wt %) as shown in FIG. 6a.

The general chemistry of how calcination of NCM-OH, AlPO₄, and Li₂CO₃ leads to a final product of modified NCM (LiNi_{0.6}Co_{0.2}Mn_{0.2}O₂) coated with Li₃PO₄ coating and elementally doped with Al is shown in the following equation.

NCM-OH+AlPO₄+Li₂CO₃→NCM(Al-doping)+Li₃PO₄+CO₂+H₂O

The thickness of the Li₃PO₄ coating varies in a range of 1 nm to 20 nm. Lithium-ion diffusion at the cathode/electrolyte interface is suppressed if the coating layer is too thick.

### Example 3—Preparation of Modified NCM Cathodes

Modified NCM-based cathodes are made up of 80 wt. % active material (i.e., the cathode material—the synthesized modified NCM), 10 wt. % poly(vinylidene difluoride) binder in N-methyl-2-pyrrolidone (NMP), 5 wt. % conductive carbon (e.g., super P, Ketjen black, or combinations thereof) and 5 wt. % vapor-grown carbon fibers (VGCF). VGCF is a type of carbon fiber material with one-dimensional morphology. The obtained slurry was cast on aluminum foil and dried overnight at 65° C. under vacuum to remove NMP. Then disc electrodes of 12 mm in diameter were punched, resulting in an average active material mass loading of 3 mg/cm² to 4 mg/cm². The cathode material is a contributor of capacity. NMP is a solvent to dissolve poly(vinylidene difluoride) binder, whose function is to adhere the slurry to the Al current. Conductive carbon with different shapes aim to construct increased electrical contact.

### Example 4—Preparation of Modified NCM Cathode-Liquid Electrolyte-Li Anode Battery

CR-2025-type coin cells were assembled with the disc cathodes of Example 3, monolayer polypropylene (PP) separator membranes, lithium foil anode, and liquid electrolyte of 1 M LiPF₆ in ethylene carbonate-dimethyl carbonate-diethyl carbonate (EC-DMC-DEC; 1:1:1 v/v/v).

### Example 5—Preparation of LLZO-Based Solid-State Electrolyte

Precursor powder LiOH·H₂O (AR, 2% excess), La₂O₃ (99.99%, calcined at 900° C. for 12 hrs), ZrO₂ (AR), and Ta₂O₅ (99.99%) were weighed according to the stoichiometric ratio of Li_{6.5}La₃Zr_{1.5}Ta_{0.5}O₁₂. Wet ball milling was carried out for 12 hrs using yttrium-stabilized zirconia (YSZ) balls as a grinding medium at a speed of 250 rpm using isopropanol as the solvent. The dried mixture power was calcined in an alumina crucible at 950° C. for 6 hrs to obtain pure cubic Li-garnet electrolyte powder. The powder was ball milled at 250 rpm for 24 hrs to obtain refined powder. Then the refined powder was pressed and calcined at 1250° C. for 30 min in a platinum crucible in air. The pellets were polished with first 400 grit and second 1200 grit sandpaper and stored in an Ar-filled glove box. The final pellet thickness is 700 μm.

### Example 6—Preparation of Modified NCM Cathode-LLZO-Based Solid-State Electrolyte-Li Anode Battery

CR-2025-type coin cells were assembled with the discs of Example 3, monolayer polypropylene (PP) separator membranes, lithium foil anode, LLZO-based cathode of Example 5, and 10 μL liquid electrolyte of 1M LiPF₆ in ethylene carbonate-dimethyl carbonate-diethyl carbonate (EC-DMC-DEC, 1:1:1 v/v/v) to wet the cathode/electrolyte interface. The Li anode was molten on the LLZTO after gold plating at the electrolyte/anode interface.

### Example 7—Characterization of Example 4 and Example 6

### Morphology and Phase Analysis

Transmission electron microscopy (TEM) images were obtained by scanning electron microscope (TEM, Tecnai G2 F20). X-ray diffraction (XRD) patterns were characterized by obtained by X-ray powder diffraction (Rigaku, Ultima IV, nickel-filtered Cu-Kα radiation, λ=1.542 Å) in the 2θ range of 10-80° at room temperature. The lattice parameter refinements were carried out using GSAS-EXPGUI software. X-ray photoelectron spectroscopy (XPS) was conducted by an ESCAlab250 system. Inductive coupled plasma mass spectrometry (ICP-MS) results were from a NexION 300D system.

### Electrochemical Performance

All the batteries were measured with LAND CT2001A battery test system (China) in a voltage range from 2.8V to 4.5V. All the batteries (Example 4 & 6) were activated at 0.1 C for threecycles before measurements were conducted at a current density of 0.2 C.

### Sample 1—Liquid Electrolyte Battery

Precursor powders NCM622-OH (Ni_{0.6}Co_{0.2}Mn_{0.2}(OH)₂) were mixed with 1 wt % AlPO₄ by stirring to dry at 60° C. Then, Li₂CO₃(>98%, 5% excess) was added by hand grinding in an agate mortar for 15 min. Thereafter, the mixture (NCM-OH, AlPO₄, and Li₂CO₃) was calcinated at 850° C. for 12 hrs in oxygen to obtain modified NCM622 powders.

The slurry comprises 80 wt. % modified NCM622, 10 wt. % poly(vinylidene difluoride) binder in NMP, 5 wt. % super P, and 5 wt. % VGCF. The obtained slurry was cast on aluminum foil and dried overnight at 65° C. under vacuum, and disc cathodes of 12 mm in diameter were punched. CR-2025-type coin cells were assembled with the disc cathodes, monolayer polypropylene (PP) separator membranes, lithium foil anode, and liquid electrolyte of 1 M LiPF₆ in ethylene carbonate-dimethyl carbonate-diethyl carbonate (EC-DMC-DEC; 1:1:1 v/v/v).

### Sample 2—Liquid Electrolyte Battery

Same as Sample 1, except the AlPO₄ content is 2 wt. %.

### Sample 3—Quasi-Solid-State Electrolyte Battery

The electrodes are the same as that in Sample 2. The quasi-solid battery was assembled where the as-obtained electrodes were used as cathode, d14 mm lithium foil as anode, LLZO as electrolyte, and 10 μL liquid electrolyte of 1 M LiPF₆ in ethylene carbonate-dimethyl carbonate-diethyl carbonate (EC-DMC-DEC, 1:1:1 v/v/v) to wet the cathode interface. The Li anode was molten on the LLZTO after gold plating. All the LLZO pellets were polished with 400 grit and then 1200 grit SiC sandpaper, resulting in the thickness of 700 μm.

### Comparative Sample 1—Liquid Electrolyte Battery

Same as Sample 1, except the AlPO₄ content is 0 wt. %.

### Comparative Sample 2—Quasi-Solid-State Electrolyte Battery

Same as Sample 3, except the AlPO₄ content is 0 wt. %.

Turning now to the figures, FIG. 3a illustrates x-ray diffraction (XRD) patterns of cathodes comprising modified NCM622 material with 1 wt. % (Sample 1), 2 wt. % (Sample 2), and 0 wt. % (Comparative Sample 1) AlPO₄. All the diffraction peaks are matched well with a typical hexagonal a-NaFeO₂ structure (JCPDF card no. 01-089-4533 with R-3m space group), which refers to the main phase of NCM622. An a-NaFeO₂-type crystal structure is of an ordered rock-salt type such that Li and Me ions occupy alternate (111) layers. NCM has a layered NaFeO₂ structure with R-3m space group with alternating layers formed by edge-sharing LiO₆ and MO₆ octahedra. From FIG. 3a, the major diffraction peaks of all samples match well with JCPDF cards with R-3m space group. A representative formula of the modified Ni-rich NCM may be LiNiₓCo_{y}Mn_{z}AₙO₂, where 0.5<x<1, 0<y<1, 0<z<1, 0≤n<0.04, A (the dopant)=Zr, Si, Sn, Nb, Ta, Al, and Fe. When the content of AlPO₄ increases from 1 wt. % to 2 wt. %, suggesting the existence of Li₃PO₄ coating (FIG. 3b). Besides, the peak splitting of (108)/(110) indicates the properties of layered structure and the differences of Comparative Sample and Sample 1-2 are attributed to the Al doping (FIG. 3c). It is concluded that the main phase of NCM622 does not change and a new second phase occurs in the modified NCM622 material. More AlPO₄ does not change the layered structure of modified NCM622 material because peaks related to the NCM622 phase are not shifted.

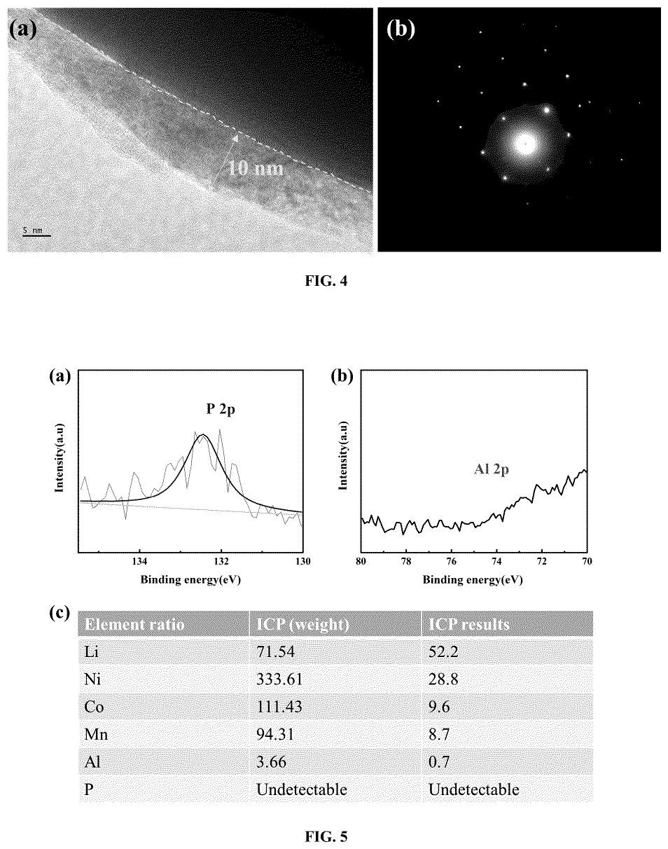

FIG. 4 illustrates a transmission electron microscopy (TEM) image and selected area electron diffraction (SAED) image of a cathode comprising modified NCM622 material with 2 wt. % AlPO₄ (Sannple 2-3). The SAED image also shows patterns corresponding to extra phase, which should be Li₃PO₄ phase (FIG. 3b).

FIG. 5 illustrates the XPS results and element ratio results of modified NCM622 cathode in Sample 1. The XPS results indicate the existence of P 2p in Li₃PO₄ coating but Al 2p peak can hardly be observed at the surface of that in Sample 1 (FIG. 5a and FIG. 5b). Combined with the quantitative analysis results by XPS and ICP, Al doping can be confirmed (FIG. 5c).

FIG. 6 illustrates the electrochemical performances of liquid batteries. FIG. 6a shows that the initial discharge capacities at 0.1 C of cells in Comparative Sample 1 and Sample 1-2 are 178.3 mAh g-1, 204.3 mAh g-1 and 171.2 mAh g-1, respectively. The much increased capacity can be achieved for Sample 1 due to the Al doping. FIG. 6b presents the cycling performances. After 300 cycles at 0.2 C over 2.8-4.5 V, the Comparative Sample 1 and Sample 1-2 show capacity retention of 63.1% (111.7 mAh g-1), 75.8% (155.0 mAh g-1) and 84.4% (136.0 mAh g-1), respectively. It is clear the modification greatly improved the cell cycling performance. It confirms the advantage of Li₃PO₄ coating and Al doping.

FIG. 7 illustrates the electrochemical performances of quasi-solid batteries. FIG. 7a shows the charge-discharge curves of cells in comparative example 2 and example 3, whose initial discharge capacities at 0.1 C are 164.0 mAh g⁻¹ and 148.8 mAh g⁻¹, respectively. FIG. 6b presents the cycling stability of NCM622 |LLZTO| molten Li and the capacity retention after 100 cycles are 7.4% and 88.3% for cells in comparative example 2 and example 3, respectively. It is clear the modification greatly improved the cell cycling performance.

Regarding Li-ion diffusion and cycling stability, charging and discharging is a process, along with electron transfer and Li-ion diffusion, at the interface and in the bulk of the material. The ability of Li-(de)intercalation and electron transfer determines diffusion polarization, ohmic polarization and activation polarization to a large extent, and polarization is an important dynamic reason for capacity retention. Li₃PO₄ coating layer is quite stable so it can protect the cathode particle from etching and side reactions caused by electrolyte. Simultaneously, Li₃PO₄ layer is beneficial for interface lithium transportation. Thus, Li₃PO₄ coating enhances the cycling stability. As for Al doping, it can enhance the bulk lithium ion transport by enlarged unit cell and strengthened layered structure. Therefore, higher discharge capacity can be achieved.

In some examples, the formed battery exhibits a capacity retention of at least 40%, or at least 50%, or at least 60%, or at least 70%, or at least 80%, or at least 90%, or at least 95%, or at least 99%, or any value or range disclosed therein, after 20 cycles. Thus, as presented herein, this disclosure relates to improved cathodes with high capacity and stability and low cost (and methods of formation thereof) for lithium-ion battery (LIB) applications. In other words, a co-modified NCM cathode with a Li₃PO₄ coating and Al doping is disclosed for both liquid electrolyte and solid-state electrolyte LIBs. This cathode was prepared by a facile one-step method using AlPO₄ and nickel-cobalt-manganese (NCM) precursor (NCM-OH). The modified NCM cathode exhibits a greatly enhanced cycling stability (capacity retention of 84.4% after 300 cycles at 0.2 C over 2.8-4.5 V in liquid electrolyte battery due to the Li₃PO₄ coating and Al doping. Quasi-solid-state batteries based on this type of cathode delivered discharge capacity of 148.8 nnAhg⁻¹ with high capacity retention of 88.3% after 100 cycles at 0.2 C over 2.8-4.5 V.

Advantages include (1) a dual-modified NCM cathode with both Li₃PO₄ coating and Al doping; (2) the Al doping can enhance the bulk lithium ion transport; ; (3) the Li₃PO₄ coating layer has great lithium ion diffusivity; (4) No usage of any organic solvent (ethanol is the only solvent) makes the method non-destructive to NCM particles and environmentally friendly.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

As utilized herein, “optional,” “optionally,” or the like are intended to mean that the subsequently described event or circumstance can or cannot occur, and that the description includes instances where the event or circumstance occurs and instances where it does not occur. The indefinite article “a” or “an” and its corresponding definite article “the” as used herein means at least one, or one or more, unless specified otherwise.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

With respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

It will be apparent to those skilled in the art that various modifications and variations can be made without departing from the spirit or scope of the claimed subject matter. Accordingly, the claimed subject matter is not to be restricted except in light of the attached claims and their equivalents.

What is claimed is:

1. A composition, comprising:
a first portion including Ni-rich LiNiₓCo_{y}Mn_{z}O₂, where 0.5<x<1, 0<y<1, 0<z<1;
a second portion including Li₃PO₄;
the second portion is coated on the first portion, and the first portion is doped with an elemental metal selected from at least one of Zr, Sn, Nb, Ta, Al, and Fe. wherein the molar ratio between Li₃PO₄ and Ni-rich LiNixCoyMnzO2 ranges from 0.76:100 to 3.8:100.

2. The composition of claim 1, wherein the elemental metal is Al.

3. The composition of claim 1, wherein the thickness of the second portion is in a range of 1-20 nm.

4. A lithium-ion battery, comprising:
a cathode;
an electrolyte; and
a lithium anode,
wherein the cathode comprises:
a first portion including Ni-rich LiNiₓCo_{y}Mn_{z}O₂, where 0.5<x<1, 0<y<1, 0<z<1;
a second portion including Li₃PO₄,
wherein:
the second portion is coated on the first portion, and
the first portion is doped with an elemental metal selected from at least one of Zr, Sn, Nb, Ta, Al, and Fe.

5. The battery of claim 3, wherein the electrolyte is a solid-state electrolyte.

6. The battery of claim 4, wherein the solid-state electrolyte comprises:
(i) Li₇₋₃ₐLa₃Zr₂LₐO₁₂, with L=Al, Ga or Fe and 0<a<0.33;
(ii) Li₇La_{3-b}Zr₂M_{b}O₁₂, with M=Bi or Y and 0<b<1; or
(iii) Li_{7-c}La₃(Zr_{2-c},N_{c})O₁₂, with N=In, Si, Ge, Sn, V, W, Te, Nb, or Ta and 0<c<1.

7. The battery of claim 5, wherein the solid-state electrolyte comprises:
Li_{6.4}La₃Zr_{1.4}Ta_{0.6}O₁₂, Li_{6.5}La₃Zr_{1.5}Ta_{0.5}O₁₂, or combinations thereof.

8. The battery of claim 5, wherein the solid-state electrolyte comprises: Li10GeP2S12, Li1.5Al0.5Ge1.5(PO4)3, Li1.4Al0.4Ti1.6(PO4)3, Li0.55La0.35TiO3, interpenetrating polymer networks of poly(ethyl acrylate) (ipn-PEA) electrolyte, three-dimensional ceramic/polymer networks, in-situ plasticized polymers, composite polymers with well-aligned ceramic nanowires, PEO-based solid-state polymers, flexible polymers, polymeric ionic liquids, in-situ formed Li3PS4, Li6PS5Cl, or combinations thereof.

9. The battery of claim 3, wherein the electrolyte is a liquid electrolyte.

10. The battery of claim 8, wherein the liquid electrolyte comprises: LiPF₆, LiBF₄, LiClO₄, lithium chelatoborates, electrolyte additive agents, fluoroethylene carbonate (FEC), tris(trinnethylsilyl)phosphate (TMSP), vinylene carbonate (VC), or combinations thereof, in an organic solvent.

11. The battery of claim 3, wherein the elemental metal is Al.

12. A method of forming a composition, comprising:
mixing a metal precursor with nickel-cobalt-manganese (NCM) precursor to form a first mixture;
adding a lithium-based compound to the first mixture to form a second mixture; and
calcining the second mixture at a predetermined temperature for a predetermined time to form the composition.

13. The method of claim 11, wherein the composition comprises:
a first portion including Ni-rich LiNiₓCo_{y}Mn_{z}O₂, where 0.5<x<1, 0<y<1, 0<z<1;
a second portion including Li₃PO₄, wherein:
the second portion is coated on the first portion, and
the first portion is doped with an elemental metal selected from at least one of Zr, Sn, Nb, Ta, Al, and Fe.

14. The method of claim 11, wherein the metal precursor is selected from at least one of a Zr-, Sn-, Nb-, Ta-, Al-, and Fe-precursor.

15. The method of claim 13, wherein the metal precursor is a Al-precursor.

16. The method of claim 11, wherein the lithium-based compound is selected from at least one of Li₂CO₃, LiOH, LiNO₃, and CH₃COOLi.

17. The method of claim 11, wherein the predetermined temperature is in a range of 700° C. to 1200° C. and the predetermined time is in a range of 8 hrs to 15 hrs.
